(19) United States
(12) Patent Application Publication
(10) Pub. No.: US 2005/0122665 A1
(43) Pub. Date: Jun. 9, 2005

(54) Shelving

(76) Inventor: Charles Daniel, Middlesex Ha8 9RW (GB)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/501,913

(22) PCT Filed: Jan. 28, 2003
(86) PCT No.: PCT/GB03/00358

(30) Foreign Application Priority Data
Jan. 28, 2002 (GB) 0201908.1

(51) Int. Cl. H02B 1/00

(52) U.S. Cl. 361/600

(57) ABSTRACT

The present invention provides a shelving system in which a least one shelf (g) is supported by at least two support members (c) period. An electrical component (e.g. a lamp (a), a display, a speaker, etc.) is mounted on the shelf or a support member. One preferably both) of the support members is arranged to provided two discrete electrically conducive paths (b) at least one of which is electrically connected to the electrical component to form part of an electrical circuit to power the electrical component.

### FIELD OF THE INVENTION

The present invention relates to shelving. It relates in particular to shelving structures incorporating electrical components such as lamps and a power supply for the electrical components or devices.

### BACKGROUND

Shelving units are built by shelving manufactures, which create box like units, out of various materials. Often shelving units are required to be lit. Under these circumstances the shelving unit would have lighting fixtures fitted to it, requiring the shelving unit to have holes drilled into it; and wires to be run over and through the unit and connected to a power point.

The lighting for each shelf would have to be predesignated, light fittings would have to be externally mounted onto the shelving units, or the prefabricated shelving units would have to be adapted and light fittings recessed into them, and fitted into that position where they would remain for the life of the shelving unit.

Each section of shelving would have to be independently wired in this manner. The shelves would be difficult to fit, as the numerous wires running behind the units all need to be joined and connected to the power point.

Once the lighting has been fitted to the shelving unit, the shelving unit becomes static. Alteration to the dimensions of the shelving then become very difficult. Even in the most flexible of shelving designs, where because the lighting fittings have been permanently fixed into position, alteration to the position of the shelves would become a difficult task.

Where shelving is used to display commercial products, a change in position of the products would usually lead to new shelving, as it would be too complicated to rearrange and re wire existing shelving. Even a change of lighting effect to a shelf would be a difficult task, as the lighting is permanently positioned onto or above the shelving unit.

The expense involved in producing a shelf, then of installing lighting into the shelf, and then the added expense of wiring it on site, is significant as this is a lengthy and complicated procedure.

There have been previous attempts to address this problem. For example, U.S. Pat. No. 4,689,726 describes a lighting arrangement for a shelf structure in which power is supplied via the supporting structure of the shelf to a lamp fixture mounted under the front edge of a shelf. One pole of the lamp (+ve/−ve) is in contact with an electrically conductive clip or hook at one end of the shelf and the other pole of the lamp (−ve/+ve) is in contact with a corresponding electrically conductive clip or hook at the opposite end of the shelf, which in turn are in contact with and supported by respective vertically extending conductive tracks. A power supply is connected across the conductive tracks. In this way, power is supplied to the lamp fixture, via the tracks and clips/hooks at opposite ends of the shelf, irrespective of where, vertically, on the conductive tracks the shelf is mounted.

Similarly, U.S. Pat. No. 6,231,205 describes a lighting arrangement for a shelving unit in which the power supply to the lamp fixture is provided via conductive shelf supports at either end of the shelf which contact respective vertically extending conductive tracks in the shelf structure enabling the lighting circuit to be completed irrespective of the vertical position of the shelf on the supporting structure.

Whilst these two US patents describe lighting arrangements that can be conveniently employed in the standalone shelving units (as they illustrate), they are not suited to larger shelving installations as one might rind, for example in shops and stores. Furthermore, the US patents do not provide the facility for a lighting source to be encompassed inside the actual support and/or shelving structures.

### SUMMARY OF THE INVENTION

It is a general aim of the present invention to provide shelving systems incorporating a power supply circuit for lighting or other electrical components/devices mounted on/in the shelves or associated support structures, that are better suited to shelving installations having Multiple shelving bays (i.e. multiple shelves side-by-side with shared support structures).

It is a particularly preferred aim to provide a shelving systems incorporating a power supply circuit for lighting or other electrical components mounted on/in the shelves or associated support structures that is modular, enabling a wide variety of different shaped and sized shelving installations to be constructed from a common set of components.

The term shelving system used herein is intended to cover any structure in which shelves or other display or storage components are supported in use by a support structure, typically including generally uprights support members. For convenience, the terms shelf and shelves are used below, but should be taken to include other display or storage components where the context allows.

In a first aspect, the present invention provides a shelving system in which at least one shelf is supported by at least two support members. An electrical component(e.g. a lamp, a display, a speaker, etc) is mounted on/in the shelf or a support member. One (preferably both or all) of the support members is arranged to provide one or two discrete or internal electrically conductive paths, at least one of which is electrically connected to the electrical component to form part of an electrical circuit to power the electrical component. Alternatively, the electrical components, (e.g. lamps) and electrically conductive paths (e.g. tracking system,) may be embodied inside the support structure, which together with a joining component forms a linkable unit.

In some embodiments the two discrete electrically conductive paths in a single support member are both electrically connected to the electrical component one to either pole of the component, (the electrical component, and or the conductive paths, being placed wholly inside the support structure, or being attached onto the support structure). The conductive paths are also connected to respective poles of a power supply to complete the electrical circuit to power the component.

Preferably, the shelving system includes two or more shelves, each of which may have an electrical component mounted thereon. These shelves may be mounted one above the other and/or back-to-back, supported by the same two support members.

Alternatively, or additionally, and particularly preferably, a plurality of shelves are mounted side-by-side. In this case, the support structure includes three or more support members, each shelf being supported by at least two of the support members and at least one of the support members providing support for two shelves, one to either side of the support member. This shared support member is arranged to provide two discrete electrically conductive paths, one of which is electrically connected to the electrical component on one of the shelves it supports and the other is electrically connected to the electrical component on the other of the shelves it supports to form respective parts of electrical circuits to power the electrical components on/in the two shelves.

The support members of the support structure may be formed with a main supporting structure that is electrically conductive and serves as one of the electrically conductive paths. The second electrically conductive path can be provided by an electrically conductive element carried by and electrically insulated from the main supporting structure of the support member. It is preferred in this arrangement that the conductive element, which may be a conductive track for example, is housed within the main structure of the support member.

Alternatively, the two electrically conductive paths may be provided by a pair of electrically conductive elements insulated from one another and carried by the main supporting structure of the support member (which in this case need not be conductive itself) Again, it is preferred that the pair of conductive elements are housed within the main supporting structure.

Where multiple shelves of the shelving system share the same supports (e.g. where they are arranged one above the other or back-to-back) they may also share the same electrically conductive paths, whether that be elements such as tracks within the support members or the main supporting structure of the support members themselves. Alternatively, particularly for back-to-back mounting of shelves, one or more discrete conductive paths may be provided for the shelf or shelves to the front of the support member, and separate, discrete conductive paths for those to the rear of the support member.

In a second aspect, the invention provides a shelving system comprising at least two shelves, each having an electrical component mounted thereon, and a support structure including, three or more support members, each shelf being supported by at least two of the support members. At least one of the support members supports two shelves, one to either side of the support member, and is arranged to provide a shared electrically conductive path, (with or without the requirement of tracks,) which is electrically connected to both of the electrical components on the shelves it supports to form respective parts of electrical circuits to power the electrical components on the two shelves.

### BRIEF DESCRIPTION OF THE DRAWINGS

The invention is described below, by way of example, with reference to the accompanying drawings in which:

FIG. 1 shows a sectioned view of a support member of a first embodiment of the invention in which a lamp is encompassed by and/or can be housed within the support member;

FIG. 2 shows a perspective view of the support member of FIG. 1

FIG. 3 shows a further sectioned view of the support member of FIG. 1; with an example of a tracking system inside.

FIG. 4 shows a shelving system according to the first embodiment including a number of support members of the form illustrated in FIG. 1;

FIG. 5 shows possible modifications to the support member or FIG. 1;

FIG. 6 shows a shelving system according to a second embodiment of the present invention;

FIG. 7 shows a schematic plan view of the shelving system of FIG. 6;

FIGS. 8 to 10 show, in schematic plan view, three alternative modified versions of the second embodiment adapted for a back-to-back shelf arrangement; and

FIG. 11 shows a shelving system according to a third embodiment of the present invention.

### DESCRIPTION OF EMBODIMENTS

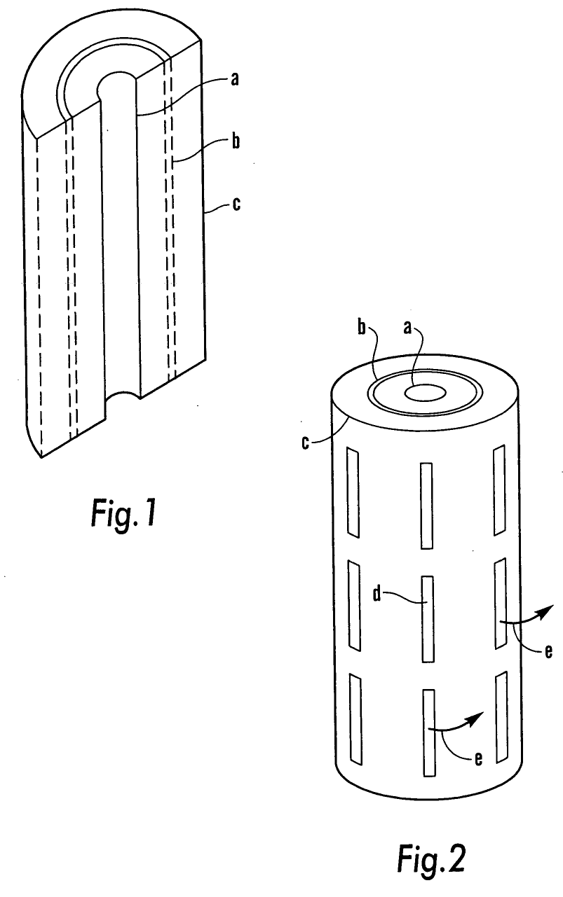

FIGS. 1 to 5 illustrate a first embodiment of the invention. As seen best in FIG. 4, a shelf system is formed from a number of support members (c) (described in more detail below). The support members (c) are joined to one another at their ends by joining members (f) to form a support structure or frame. The frame in turn supports shelf panels (g), which can be supported horizontally, vertically, or at an angle to create the desired shelving or display unit.

In the arrangement seen in FIG. 4 the support frame is formed from 20 support members (e) configured to form three square, horizontally oriented frames (each formed from four support members), stacked one above the other and held spaced from one another by eight vertical support members Arranged in four columns, one at each corner of the sqaure frames. It will be appreciated, however, that the support members can be connected to one another in any of a large number of different configurations to create a great variety of sizes and shapes of support structure.

In accordance with a preferred embodiment of the invention, each of the support members (c) houses a lamp (a) (seen best in FIGS. 1 and 2), the power supply for which is conducted through the support members (c) from a transformer (not shown) connected to a mains power supply. A series of slits (d) are formed in the outside of each support member (a) through which the light from the lamp is emitted (e) to illuminate the shelf panels. The slits (d) can be selectively blanked off to more precisely control the emission of the light.

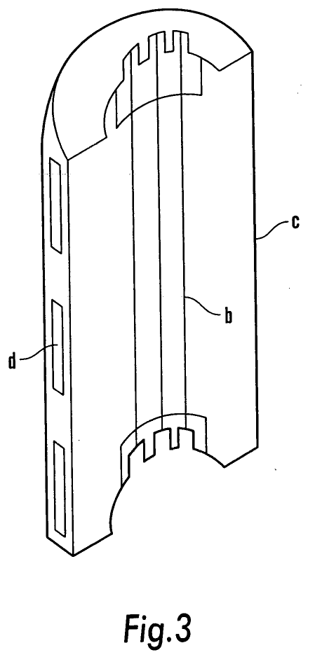

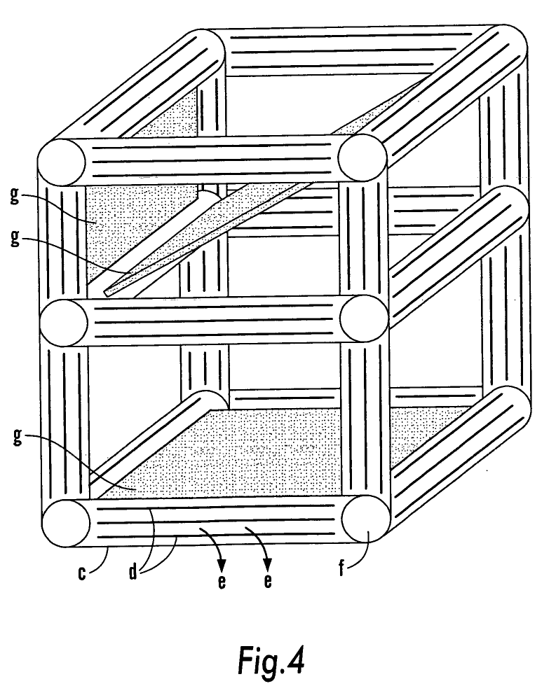

Referring to FIGS. 1 and 3, each support member houses electrically conductive tracking (b) for supplying power to the lamps. It is possible for each support member (c) to house a pair of tracks (b) insulated from one another and electrically connected to respective positive and negative poles of the power supply. The lamp (a) is then connected (electrically) across the two tracks to complete the circuit. Alternatively, where the support member is itself conductive, it need only be provided with a single track connected to one pole of the power supply, the body of the support member itself being connected to the other pole and the lamp being connected across the single track and the body of the support member. In this case the support member body must of course be electrically insulated from the track within it.

The joining members (f), that join the ends of the support members (a), also have internal conductors (not shown) that serve to electrically connect the respective tracks (or track and support member body) of adjacent support members so that power can be conducted from one to the other. In this way, the transformer/power supply need only be connected to one or the support members (e.g. one at the base of the support structure (c)) to supply all of the lamps in the structure.

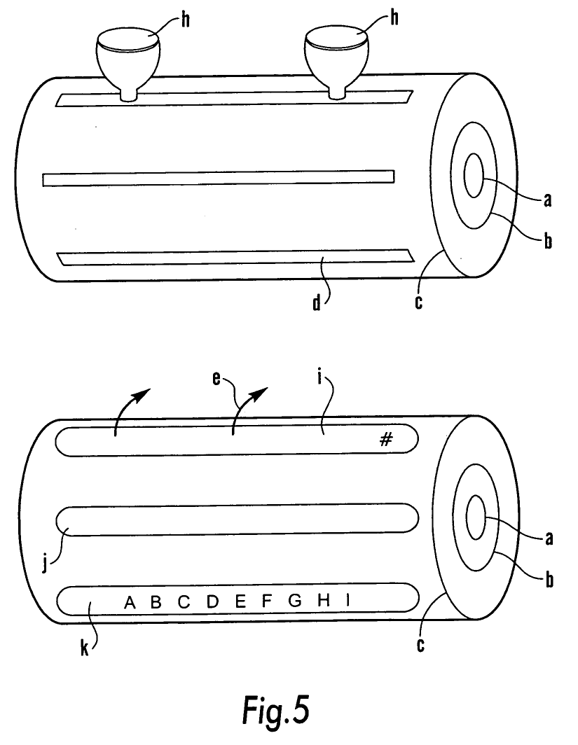

The electrical supply provided by the support members can also be made accessible from outside the support members, for instance by having the track or tracks exposed within the slits (d) in the walls of the support members, whereby electrical contact elements can be inserted into the slits to draw power from the support members. This may be used, for example, for additional lighting (h) (see FIG. 5) mounted on the outside of the support member or on the shelf panels themselves for example.

The slits (d) can also be adapted to accept other electrical and non-electrical accessories. FIG. 5 illustrates some examples including coloured filters (i) to alter the colour of the emitted light from the internal lamps (a), light blocks (j) to prevent emission of light from some or all of the slits (d), and labelling tags (k) used, for example, to label products displayed on the shelving. Furthermore, visual display screens or audio speakers, (not illustrated) may utilise the power to function.

To assemble the shelving system, the frame (c) is first constructed from the support members, which are locked to one another by the joining members (f) to structurally and electrically connect the support members to one another. Shelf panels (g), or other display and storage components can the be engaged in the slits (d) of the support members to be suspended within the frame.

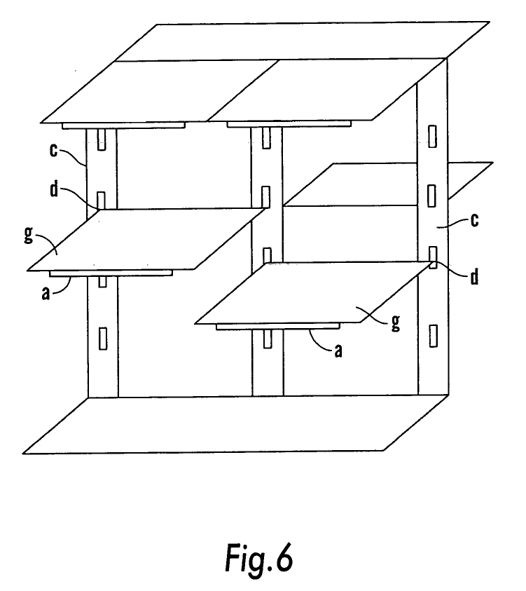

FIG. 6 illustrates a shelving system according to a second embodiment of the invention. In this embodiment shelf units (g) are suspended from upright support members (c). More specifically, in this example, the support members (c) have a series of openings (d) along the length of their front faces adapted to receive mounting elements (not show) such as hooks or pins protruding from the rear edge at either side of each shelf.

As seen in FIG. 6 each shelf (g) is supported by two or more of the upright support members (c)—in this example some of the shelves span three supports and some of the shelves pan only two supports, sharing the middle support of the three illustrated. As will be apparent, the shelving system can be easily expanded to incorporate additional support members and additional shelves.

In the illustrated example, each of the shelves (with the possible exception of the one at the base of the structure) has a light fitting (a) mounted on its underside adjacent to its front edge. Power is supplied to the light fitting (a) via the support members (c) in the manner described below.

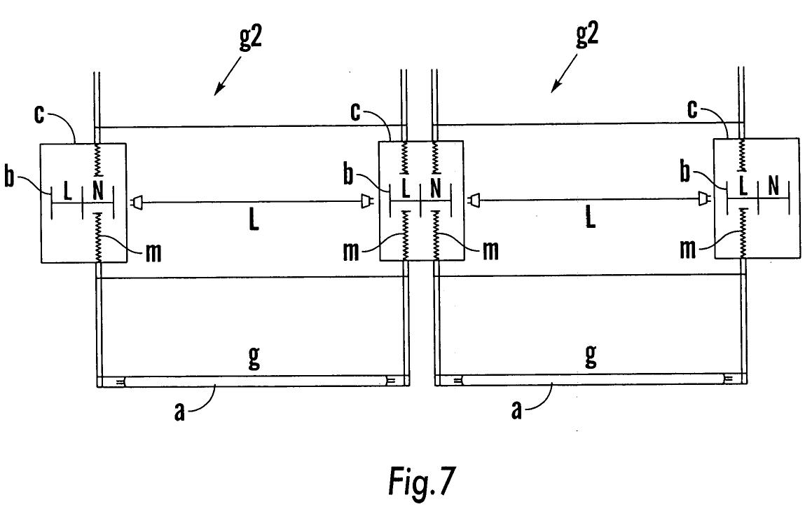

Looking at FIG. 7, which is a schematic plan view looking down on the topmost two shelves seen in FIG. 6, it can be seen that each of the upright support members (c) houses a pair of conductive tracks (b) (or other conductive elements) of opposite polarity. The tracks of the right hand support member are connected to an external power supply (not illustrated). The tracks of the other supports could likewise be connected directly to external power supplies of their owns but more preferably, as illustrated here, adjacent support members are connected by link wires (l) that electrically connect tracks of the same polarity to one another in the adjacent supports. In this way, as single power supply can serve multiple supports.

Each of the shelves has an electrically conductive, sprung plunger (a) mounted at its rear edge, one to either end of the shelf (g) adjacent the support columns (c), extending rearward beyond the mounting elements of the shelf. Each of the plungers (m) is electrically connected to a respective pole of the light fitting (a), for example via a conductor track extending from the plunger to the light fitting (and where the shelf is itself conductive, insulated from the shelf). When the shelf (g) is suspended from the support members (c), the plungers (m) pass into the interiors of the support members and make contact with respective conductive tracks (b), completing the electric circuit to power a lamp (a) in the light fitting.

FIG. 7 also illustrates how the shelf system can accommodate rows of back-to-back shelves. More spacfically, additional shelves (g2), seen towards the top of the figure, are suspended from the rear face of the upright support members (c) in the same manner as described above for those suspended from the front face. As seen in the figure, the contact plungers (m) of these additional shelves, when they are suspended in position on the supports, make contact with the same conductive tracks (b) (but to the rear side).

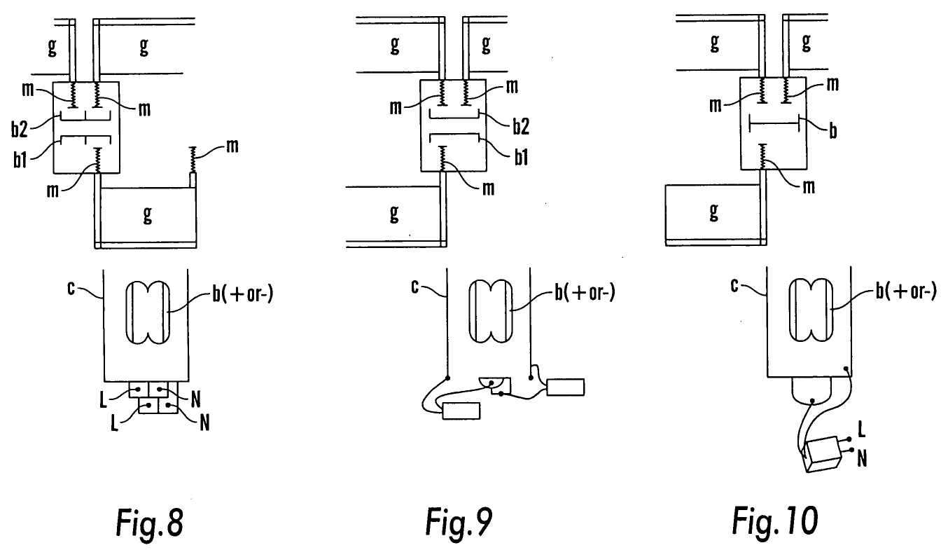

FIG. 8 illustrates, scematically, an alternative arrangement of conductors (b) within the upright support members (c). Rather that the front and rear shelves sharing the same pair of conductive tracks, the support member houses two pairs of tracks (b), one pair (+ and −) for the front shelves (b1) and one pair (b2) for the back shelves. Corresponding tracks of each pair may still share a connection to the same power supply or, alternatively, separate power supplies may be provided.

FIG. 9 shows another alternative. In this arrangement there is only a single conductive track (+ or −) for the front shelves (b1) and a single track (b2) for the rear shelves. The conductive path for the other pole is provided by the support member (c) itself. Thus, one pole of the power supplies is connected to the tracks (b) and the other pole to the main body of the support, which in turn is connected to one pole of the light fitting (a) through the shelf itself (g), which is conductive in this example. In this case, the tracks (b) must obviously be insulated from the conductive support member (c) and the plunger (m) and its connection to the light fitting (a) insulated from the shelf (g).

FIG. 10 illustrates yet another possible power supply arrangement. Like the arrangement of FIG. 9, the support member (c) itself serves as a conductor for one pole of the electrical supply. However, unlike FIG. 9, but similar to FIG. 8, the front and rear shelves (g) share a single conductive track (b) housed within and insulated from the support (c) for the other polarity of the supply.

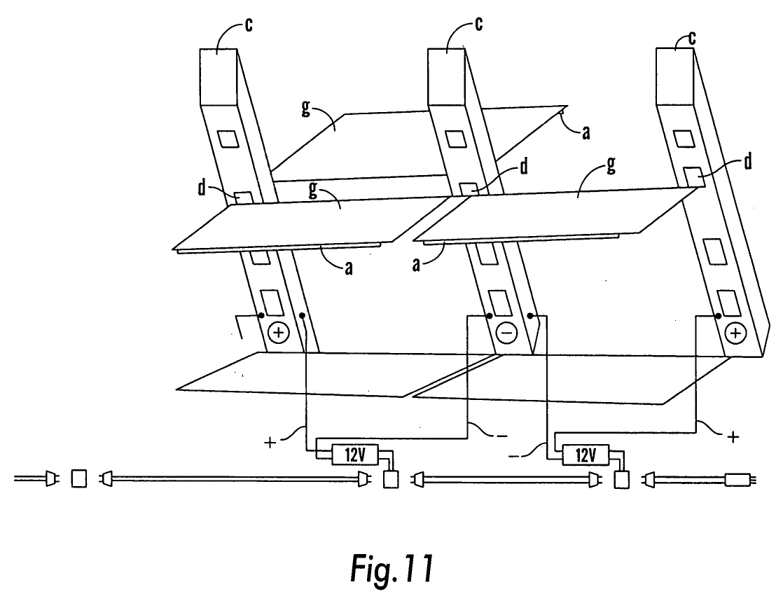

FIG. 11 illustrates a third embodiment of the invention. The shelving system seen in this figure comprises a number of shelves suspended from upright support members (c) by mounting elements (e.g. hooks or pins) protruding from the rear corners of the shelves, as described above. Each shelf (g) has a light fitting (a) mounted on it.

In this embodiment, however, there are no conductive tracks within the support members (c). Rather, the support members themselves provide both polarities of the power supply. More specifically, the support (c) to one side of a shelf is connected to one pole of the power supply, and the support (c) to the other side of a shelf is connected to the other pole of the power supply. Power is transmitted to the light fitting (a) from the support columns (c) via the mounting elements (d), which are conductive. Further conductive elements may be required to carry the power to light source (a), although the shelf itself may do this. The structure of the shelf and the conductors in it is arranged to ensure that there is no electrical short circuit across the shelf between the two support columns (c). For intance, the shelf may be formed of a non-conducting material.

It will be appreciated that the structures of the various embodiments of the invention described above allow the shelving systems to be reconfigured very easily, the electrical connections for the lamps (or other powered accessories) being broken and made ‘automatically’ as the frames are disassembled and reassembled. The systems can thus potentially avoid completely the need for re-wiring shelf lighting when e.g. a shop display is rearranged.

It will be appreciated that the above description is given by way of example only and many modifications can be made to that which has been specifically described without departing from the scope of the invention. For instance, whilst the examples have principally shown the use of the innovative power supply structures to light a lamp, the same arragments can be employed to power other electrical components such as display (e.g. plasma screens, speakers, etc.) Similarly, the examples show flat shelves mounted on the support structres, but the invention is equally applicable to other forms of display and storage components that can be mounted on such support structures (e.g. hanging rails.)

1. A shelving system comprising:
at least one shelf;
a support structure having at least two support members that serve to support the shelf; and
an electrical component mounted on or in the shelf or a support member;
at least one of the support members being arranged to provide two discrete electrically conductive paths, at least one of which is electrically connected to the electrical component to form part of an electrical circuit to power the electrical component.

2. A shelving system according to claim 1, wherein said two discrete electrically conductive paths are both electrically connected to said component, one to either pole of the component, said conductive paths also being connected to respective poles of a power supply to complete the electrical circuit to power said component.

3. A shelving system according claim 1, comprising:
at least two shelves, each having an electrical component mounted thereon:
wherein the support structure includes three or more support members, each shelf being supported by at least two of the support members;
at least one of the support members providing support for two shelves, one to either side of the support member, and the support member being arranged to provide two discrete electrically conductive paths, one of which is electrically connected to the electrical component on one of said shelves it supports and the other is electrically connected to the electrical component on the other of said shelves it supports to form respective parts of electrical circuits to power the electrical components on the two shelves.

4. A shelving system according to any one of the preceding claims, wherein said at least one support member has a main supporting structure that is electrically conductive and serves as one of said electrically conductive paths, an electrically conductive element carried by and electrically insulated from the main structure of the support member serving as the other of said electrically conductive paths.

5. A shelving system according to claim 4, wherein said electrically conductive element is housed within said main support structure.

6. A shelving system according to any one of claims 1 to 3, wherein said at least one support member has a main supporting structure and said two electrically conductive paths are provided by a pair of electrically conductive elements insulated from one another and carried by said main supporting structure of the support member.

7. A shelving system according to claim 6, wherein said pair of conductive elements are housed within said main supporting structure.

8. A shelving system according to any one of the preceding claims, wherein two or more shelves of the system having electrical components mounted thereon share the same electrically conductive paths to power their electrical components.

9. A shelving system according to claim 8, wherein said two or more shelves are mounted one above the other.

10. A shelving system according to claim 8, wherein two shelves sharing the same electrically conductive paths are mounted either back-to-back or side-by-side.

11. A shelving system according to any one of the preceding claims, wherein said electrical component is a lamp, or light source of any kind whatsoever; and/or the power supply being mains, low voltage, extra low voltage, single phase, three phase or any other system of power supply whatsoever.

12. A shelving system comprising:
at least two shelves, each having an electrical component mounted thereon; and
a support structure including three or more support members, each shelf being supported by at least two of the support members;
at least one of the support members providing support for two shelves, one to either side of the support member, and the support member being arranged to provide a shared electrically conductive path which is electrically connected to both of the electrical components on said shelves it supports to form respective parts of electrical circuits to power the electrical components on the two shelves.
